(19) United States
(12) Patent Application Publication
(10) Pub. No.: US 2003/0230609 A1
(43) Pub. Date: Dec. 18, 2003

(54) Box structure for fixing folding bicycle

(76) Inventor: Yu-Hsueh Chu, Taipei (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 10/170,463

(22) Filed: Jun. 14, 2002

(51) Int. Cl. B62J 7/00; B62J 9/00; B62J 11/00; A45F 4/00; A45C 15/00

(52) U.S. Cl. 224/423; 224/431; 224/585

(57) ABSTRACT

A box structure for fixing folding bicycle comprises a positioning device comprising a body member being connected to fold bicycle and a positioning member; and a box device comprising a body locating a chute in one side that being connected to a draw bar means and a positioning hole which providing to fasten to said positioning device by plunging said positioning member.

### FIELD OF THE INVENTION

The present invention relates, in general, to a box structure, and in particular, to provide a device to keep folding bicycle and couple to the folding bicycle in order to bring for convenience.

### BACKGROUND OF THE INVENTION

The bicycle is one of the tools to replace walking and it is a exercise and a leisure action in one of quality modern times. So the bicycle is very loved in modern times according to properties of exercise and leisure. In order to bring for convenience whether in habitat or go out, the structure of bicycle adapts to shrink. More important, the bicycle already has developed the folding structure, adding mobility and usability, in order to be carried by car or others vehicles. Meanwhile, the folding bicycle does not couple to box device for taking design in present. The folding bicycle is folded which could not be treasured so that it is easy to damage or harm somebody. The folding bicycle that it is hard to use in modern life such as hand-carry on safety in rapid transit, vehicles and transports results in above mention.

### SUMMARY OF THE INVENTION

Therefore it is an object of the invention to provide a box structure for fixing of folding bicycle and couple to the folding bicycle wherein the box could not encumber while riding.

Another object of this invention to provide a box for fixing folding bicycle that it is easy to carry and expand the using.

Still another object of this invention to provide a box to carry baggage or fixing tools.

A still further object of the invention to provide a advantage for rapid, safety and convenient of combining and dismount.

### BRIEF DESCRIPTION OF THE DRAWINGS

The appended claims particularly point out and distinctly claim the subject matter of this invention. The various objects, advantages and novel features of this invention will be more fully apparent from a reading of the following detailed description in conjunction with the accompanying drawings in which like reference numerals refers to like parts, and in which:

FIG. 1 is a schematic drawing of this pictorial invention;

FIG. 2 is a schematic drawing of the body device of this invention;

FIG. 3 is a schematic drawing of the positioning bar of this invention;

FIG. 4 is a schematic drawing of the extend bar of this invention;

FIGS. 5 to 8 is a schematic drawing of the box device of this invention;

FIG. 9 is an assembly drawing for side view of this invention; and

FIG. 10 is a schematic drawing for part of this invention.

### DETAILED DESCRIPTION OF THE PREFERRED EMBODIMENT

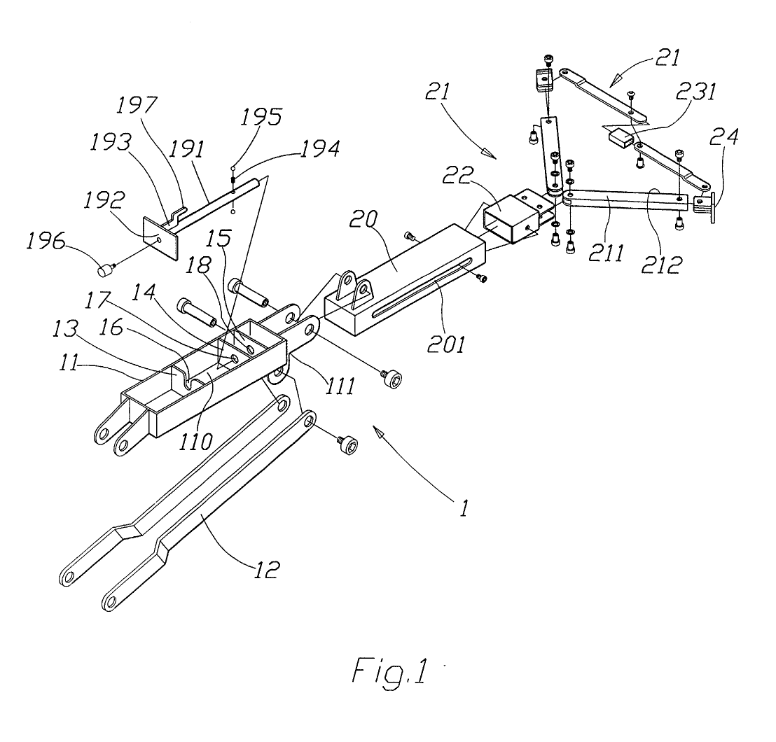

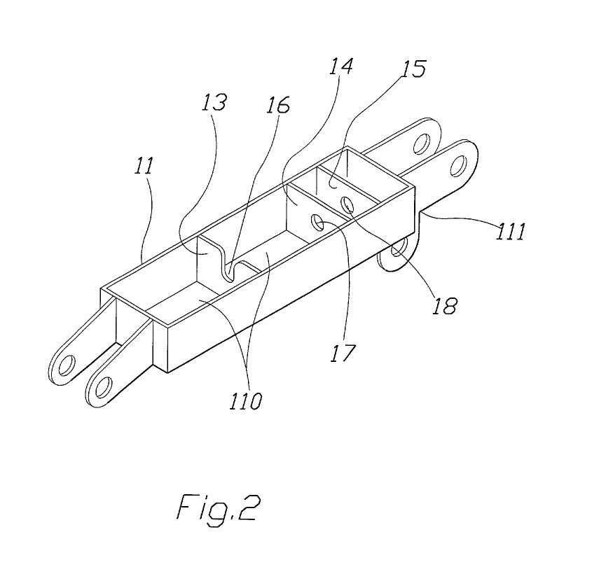

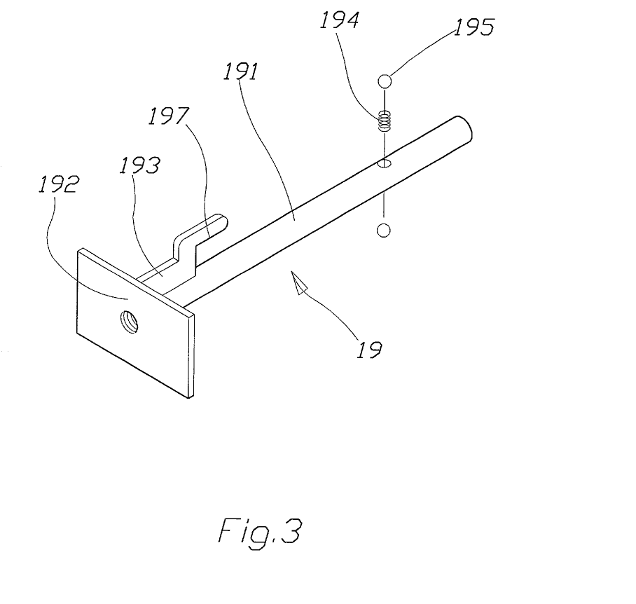

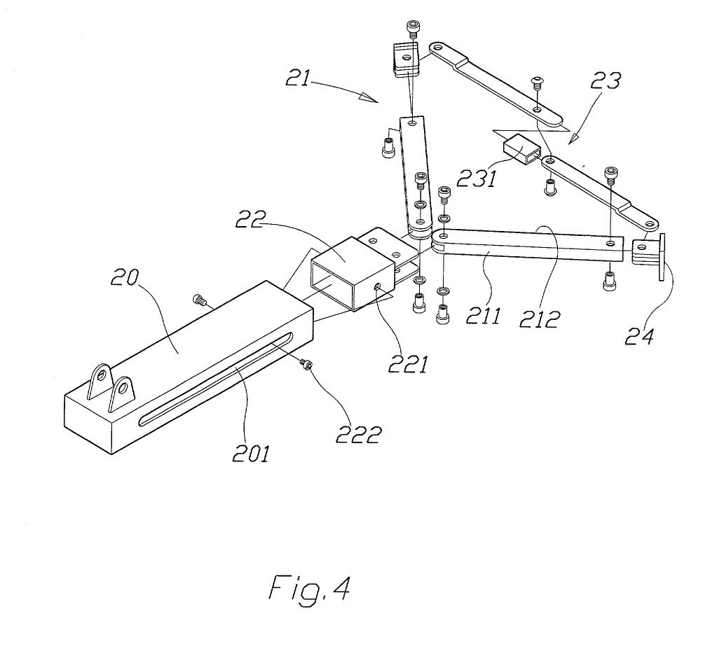

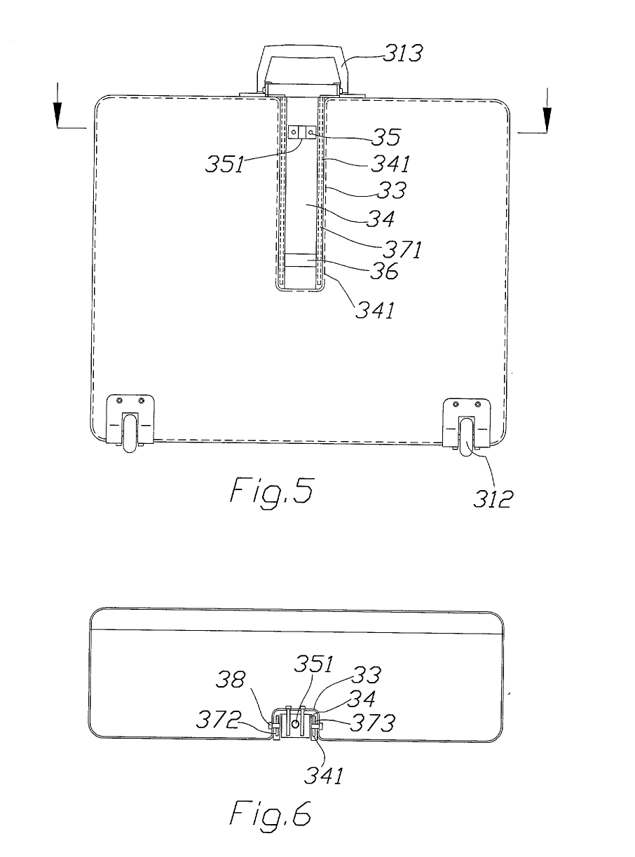

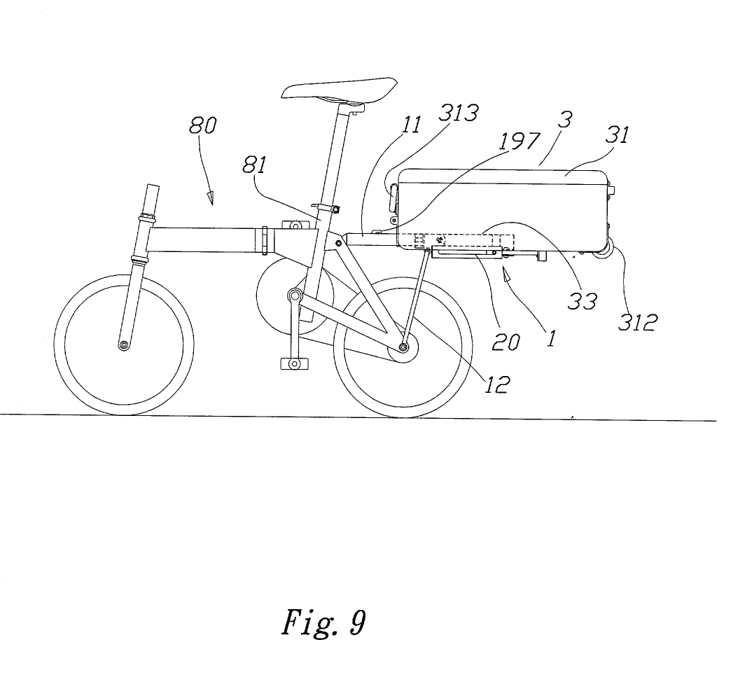

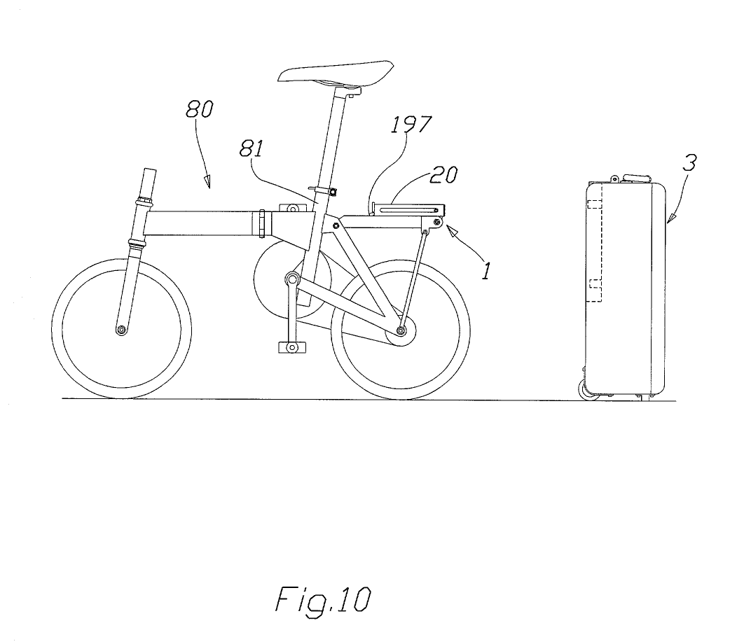

Referring to FIGS. 1 and 9, the box for fixing folding bicycle comprises a positioning device 1 and a box device 3. The positioning device 1 includes a body member 11 which the frontward of body member 11 couples to rear rack 81 of bicycle 80 and taking a rod 12 connects backward of body member 11 and rear rack 81 of bicycle 80 in order to position of body member 11. The body member 11 having a hollow 110 which divided into three parts by baffles the first baffle 13 locating a concavity 16 and the second 14 and third 15 baffles locating holes 17, 18. (please also refer to FIG. 2) And, the backward end of body member 11 locates a stopping element 111. The body member 11 further includes a positioning member 19 which positions the body member 11 and the box device 3. (please also refer to FIG. 3) wherein the positioning member 19 comprises a bar 191, a sheet bar 192 and a panel 193. The bar 191 is located the concavity 16 of first baffle 13 through the hole 17, 18 of second baffle 14 and third baffle 15, and the bar 191 locating a spring 194 and ball bearing 195 is opposed to the third baffle 15. The sheet bar 192 is convenient to make the positioning member 19 settled on the body member 11 and shift operation by a nut 196. And, the panel 193 installs the end 197 of the positioning member 19 which the end 197 is protrudent out of the body member 11. The positioning member 19 couples to a extend bar 20 which could move forward and backward operation. (please refer to FIG. 4) and the extend bar 20 being tubular form locates a groove 201 on two sides and it is positioned by end of positioning member 19 when assembles with body member 11. Referring to FIG. 10, the top of extend bar 20 is stopped by the end 197 of positioning member 19 when it couples to the body member 11. Referring to FIG. 5, the end of the body member 11 installs a stopping element 111 which stops the extend bar 20 when moved backward end. Further more, also referring to FIG. 4, the extend bar 20 also couples to a holding device 21 which comprises two holding bars 211 and a connecting device 22, the two holding bars 211 coupling to the connecting device 22, and the opposed side of holding bar 211 is located to a recess 212 by locating the connecting bar 23. The holding bar 211 couples to a connecting device 22 which connects inside of extend bar and the side of connecting device 22 locating a hole 221 couples to said groove 201 of extend bar 20 by a positioning pin 222 in order to make the holding device 21 moving in or out and keeping in the extend bar 20. The connecting bars 23 connect each other with a fastening element 231 and couples to a connecting bar 23 between them which is a flectional connecting structure. The end of holding bar 211 locates a pulling means 24 in order that said holding bars 211 operate for convenience.

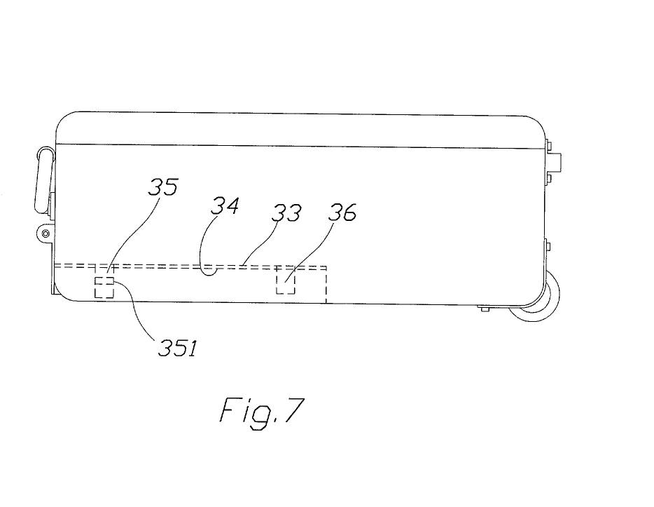

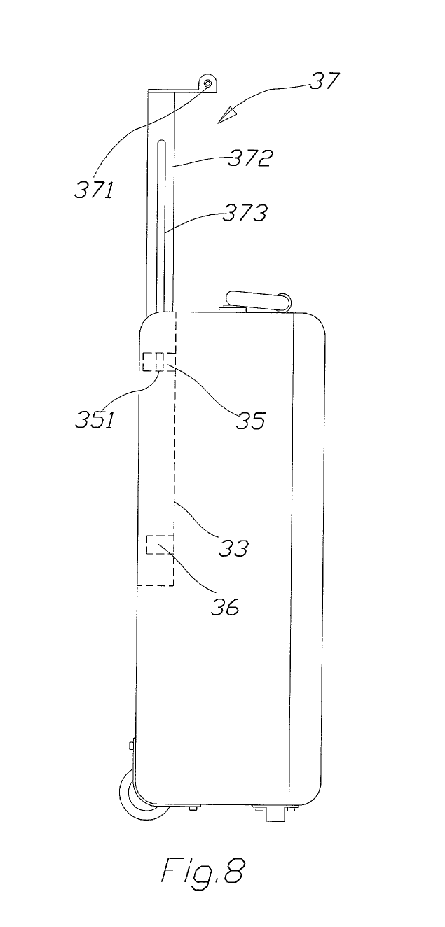

Referring to FIGS. 5 to 8, the box device 3 comprises a body 31 including wheels 312 and a handle 313 and the side of body 31 locates a alcove 33 which comprises a guiding means 34 fastened on the body 31 by positioning elements 35,36. The both side of guiding means 34 locate chutes 341. Besides, the positioning element 35 locating a hole 351 is fastened on the body 31 by a pin 191. Further more, the box device 3 further comprises a draw bar means 37 which includes a handle 371 and drag rods 372 in both sides of it which couple to the chute 341, and the drag rod 372 locates a groove 373 which couples to the body 31 by a pin 38 in order to limit the extend length.

Referring to FIGS. 9 and 10, first the end 197 of positioning member 19 does not position to the extend bar when assembles the box device 3 and positioning device 1. Second, the extend bar 20 takes backward and to stretch the holding bar 211 opens form extend bar 20. The box device 31 locates onto the body device 1 and the positioning elements 35,36 locate respective to the extend bar and the recession of third baffle 15 of body member 11. Also, the box device 3 is fastened by the bar 191 inserting to the hole 351 of positioning element 35. However, the folding bicycle is folded for convenience by removing the box device 3.

While this invention has been described in reference to illustrative embodiments, this description is not intended to be construed in a limiting sense. Various modifications and combinations of the illustrative embodiments, as well as other embodiment of the invention, will be apparent to persons skilled in the art upon reference to the description. The teachings and concepts of the present invention may be applied to other types of components, systems and structures the principles of the present invention are practicable in a number of applications and technologies. It is therefore intended that the appended claims encompass any such modifications or embodiments.

What is claimed is:

1. A box structure for fixing folding bicycle comprising:
a positioning device comprising a body member being connected to fold bicycle and a positioning member; and
a box device comprising a body locating a chute in one side that being connected to a draw bar means and a positioning hole which providing to fasten to said positioning device by plunging said positioning member.

2. A box structure for fixing folding bicycle as claimed in claim 1, wherein said top of positioning device is connected to rear rack of folding bicycle by screwing and rear of it is connected to rear rack of folding bicycle by a rod.

3. A box structure for fixing folding bicycle as claimed in claim 1, wherein said positioning device locates a hollow body which divided into three parts by baffles the first baffle locating a concavity and the second and third baffles locating holes.

4. A box structure for fixing folding bicycle as claimed in claim 1, wherein said positioning member comprises a bar, a sheet bar and a panel.

5. A box structure for fixing folding bicycle as claimed in claim 3 or 4, wherein said bar is located to said concavity of first baffle through holes of second and third baffles.

6. A box structure for fixing folding bicycle as claimed in claim 3 or 4, wherein said bar locating a spring and ball bearing is opposed to the third baffle.

7. A box structure for fixing folding bicycle as claimed in claim 4, wherein said sheet bar is convenient to make said positioning member settled on said body and shift operation by a nut.

8. A box structure for fixing folding bicycle as claimed in claim 1, wherein said positioning member couples to a extend bar which could move forward and backward operation.

9. A box structure for fixing folding bicycle as claimed in claim 4 or 8, wherein said extend bar being tubular form locates a groove on two sides and it is positioned by end of positioning member when assembles with positioning device.

10. A box structure for fixing folding bicycle as claimed in claim 8, wherein end of said body installs a stopping element which stops said extend bar when moved backward end.

11. A box structure for fixing folding bicycle as claimed in claim 8, wherein said extend bar couples to a holding device which comprises two holding bars that couples to a connecting bar between them which is a flectional connecting structure.

12. A box structure for fixing folding bicycle as claimed in claim 11, wherein said opposed side of holding bar is located to a recess by locating a connecting bar.

13. A box structure for fixing of folding bicycle as claimed in claim 11, wherein said holding bar couples to a connecting device which connects inside of extend bar.

14. A box structure for fixing folding bicycle as claimed in claim 13, wherein said side of connecting device locating a hole couples to said groove of extend bar by a positioning pin in order to make said holding device moving in or out and keeping in said extend bar.

15. A box structure for fixing folding bicycle as claimed in claim 11, wherein said connecting bars connect each other with a fastening element.

16. A box structure for fixing folding bicycle as claimed in claim 11, wherein said end of holding bar locates a pulling means in order that said holding bars operate for convenience.

17. A box structure for fixing folding bicycle as claimed in claim 1, wherein said side of box device locates a alcove which comprises a guiding means fastened on said box device by a positioning element.

18. A box structure for fixing folding bicycle as claimed in claim 17, wherein said both side of guiding means locate chutes.

19. A box structure for fixing folding bicycle as claimed in claim 4 or 17, wherein said positioning element locating a hole is fastened on said box device by a pin.

20. A box structure for fixing folding bicycle as claimed in claim 1, said draw bar means comprises a handle and drag rods in both sides of it which couple to said chute.

21. A box structure for fixing folding bicycle as claimed in claim 20, wherein said drag rod locates a groove which couples to said box device by a pin in order to limit the extend length.
